(19) United States
(12) Patent Application Publication
(10) Pub. No.: US 2015/0076045 A1
(43) Pub. Date: Mar. 19, 2015

(54) PURIFICATION METHOD AND APPARATUS FOR RADIOACTIVE WASTEWATER CONTAINING IODINE RADIONUCLIDES

(71) Applicant: KOREA ATOMIC ENERGY RESEARCH INSTITUTE, Daejeon (KR)

(72) Inventors: Seung Yeop LEE, Daejeon (KR); Ji Young LEE, Busan (KR); Jong Tae JEONG, Daejeon (KR); Kyung Su KIM, Seoul (KR)

(73) Assignee: KOREA ATOMIC ENERGY RESEARCH INSTITUTE, Daejeon (KR)

(21) Appl. No.: 14/133,824

(22) Filed: Dec. 19, 2013

(30) Foreign Application Priority Data
Sep. 13, 2013 (KR) 10-2013-0110688

(51) Int. Cl. C02F 3/28

(52) U.S. Cl. CPC C02F 3/2813
USPC 210/96.1; 210/205; 210/206

(57) ABSTRACT

Provided are a purification method and apparatus for radioactive wastewater. The purification method and apparatus for radioactive wastewater according to the present invention, which is a biological purification apparatus for radioactive wastewater containing radioactive iodine, includes: an anoxic tank into which wastewater containing radioactive iodine is introduced; and a microbial purification tank connected to the anoxic tank so as to allow wastewater in an anaerobic state to be introduced and supplied with a metal reducing bacteria source, an electron donor, and a copper ion source, wherein radioactive iodine and copper ions are bound to each other to form copper iodide by metal reducing bacteria, and the formed copper iodide is precipitated in the microbial purification tank, such that the radioactive iodide in the wastewater is removed as sludge.

### CROSS-REFERENCE TO RELATED APPLICATIONS

This application claims priority under 35 U.S.C. §119 to Korean Patent Application No. 10-2013-0110688, filed on Sep. 13, 2013, in the Korean Intellectual Property Office, the disclosure of which is incorporated herein by reference in its entirety.

### TECHNICAL FIELD

The following disclosure relates to a biological purification method and apparatus for radioactive wastewater containing iodine radionuclides.

### BACKGROUND

Since it is not easy to remove iodine present in an aqueous solution, removal of iodine from radioactive wastewater generated in a nuclear power plant, an institution using a radioisotope, or the like, has been a big problem.

In the case of iodine-125, iodine-131, iodine-132, iodine-133, and the like, that have a relatively short half life, radioactivity may be attenuated by leaving wastewater for a predetermined period, but since a generation amount of radioactive wastewater containing iodine nuclides is excessively large, it is realistically impossible to purify the radioactive wastewater by storing the radioactive wastewater itself in a water collecting tank for a long time. Further, a half life of iodine-129 is significantly long, such that attenuation of radioactivity by leaving iodine-129 is almost impossible, and in the case of intake of iodine-129 in a human body, iodine-129 is concentrated in the human body and continuously release radiation, such that iodine-129 is significantly harmful.

In order to purify the radioactive wastewater containing the iodine nuclides, radioactive iodine is coagulated and removed using activated carbon, anion exchange resin, or the like, as in Korean Patent Laid-Open Publication No. 2010-0030250, but even in the case of using the activated carbon, the anion exchange resin, or the like, since the activated carbon or the anion exchange resin should be frequently exchanged, a large amount of secondary radioactive waste are generated, and high cost is consumed. In addition, in the case in which the wastewater contains high concentration radioactive iodine, there is a limitation in removing iodine by adsorption process alone using the activated carbon or an ion exchange method.

### RELATED ART DOCUMENT

### Patent Document

Korean Patent Laid-Open Publication No. 2010-0030250

### SUMMARY

An embodiment of the present invention is directed to providing a purification method and apparatus for radioactive wastewater containing iodine nuclides. In detail, an object of the present invention is to provide a purification method and apparatus for radioactive wastewater capable of economically and rapidly purifying radioactive wastewater, treating high level radioactive wastewater, significantly decreasing an amount of radioactive wastes generated at the time of purifying wastewater, and significantly stably removing iodide nuclides.

In one general aspect, a purification apparatus for radioactive wastewater, which is a purification apparatus for wastewater containing radioactive iodine, the purification apparatus includes: an anoxic tank into which wastewater containing radioactive iodine is introduced; and a microbial purification tank connected to the anoxic tank so as to allow wastewater in an anaerobic state to be introduced and supplied with a metal reducing bacteria source, an electron donor, and a copper ion source, wherein radioactive iodine and copper ions are bound to each other to form copper iodide by metal reducing bacteria, and the formed copper iodide is precipitated in the microbial purification tank, such that the radioactive iodide in the wastewater is removed as sludge.

The purification apparatus for radioactive wastewater may further include: a first transfer pipe allowing the anoxic tank and the microbial purification tank to communicate with each other so as to be openable and closable; a first transfer pump connected to the first transfer pipe to transfer the wastewater in the anoxic tank to the microbial purification tank; a sludge discharge pipe installed so as to communicate with a lower portion of the microbial purification tank to thereby be openable and closable; and a sludge discharge pump connected to the sludge discharge pipe to discharge the sludge from the microbial purification tank.

The purification apparatus for radioactive wastewater may further include: a metal reducing bacteria source storage tank, an electron donor storage tank, and a copper ion source storage tank connected to the microbial purification tank, respectively.

The purification apparatus for radioactive wastewater may further include a control part, wherein the control part injects the metal reducing bacteria source so that at most 100 ppm metal reducing bacteria is injected thereinto, based on a protein amount of the metal reducing bacteria.

The control part may inject the copper ion source so that 1 to 1.5 mM copper ion is interacted with 1 mM radioactive iodine contained in the wastewater.

The metal reducing bacteria may be any one or at least two selected from Pseudomonas, Shewanella, Chlostridium, Desulfovibrio, Desulfosporosinus, Desulfotomaculum, Anaeromyxobacter, and Geobacter genera.

The metal reducing bacteria source may be metal reducing bacteria powder or a culture medium containing the metal reducing bacteria.

The electron donor may be one or at least two selected from a carboxylic group containing organic acid, a sulfonic acid group containing organic acid, and hydrogen gas.

### BRIEF DESCRIPTION OF THE DRAWINGS

FIG. 1 is a configuration diagram of a purification apparatus of radioactive wastewater according to an exemplary embodiment of the present invention;

FIG. 2 is another configuration diagram of the purification apparatus of radioactive wastewater according to an exemplary embodiment of the present invention;

FIG. 3 is a diagram showing a measured removal rate of iodine in an aqueous solution containing iodide ions according to the exemplary embodiment of the present invention; and

FIG. 4 is a diagram showing an electron microscope photograph obtained by observing a crystalline mineral of copper iodide formed by biomineralization according to an exemplary embodiment of the present invention, and result of element analysis.

### DETAILED DESCRIPTION OF MAIN ELEMENTS

110: Anoxic tank
120: Microbial purification tank
111: Reducing agent storage tank
121: Metal reducing bacteria source storage tank
122: Electron donor storage tank
123: Copper ion source storage tank
10: First transfer pipe
20: First pump
30: Sludgy discharge pipe
40: Sludgy discharge pump
50: Purification water discharge pipe
60: Purification water discharge pump
70: Radioactive wastewater inflow pipe
200: Control part

### DETAILED DESCRIPTION OF EMBODIMENTS

Hereinafter, a purification method and apparatus for radioactive wastewater according to an exemplary present invention will be described in detail with reference to the accompanying drawings. The drawings to be provided below are provided by way of example so that the idea of the present invention can be sufficiently transported to those skilled in the art. Therefore, the present invention is not limited to the drawings to be provided below, but may be modified in many different forms. In addition, the drawings to be provided below may be exaggerated in order to clarify the scope of the present invention. Here, technical terms and scientific terms used in the present specification have the general meaning understood by those skilled in the art to which the present invention pertains unless otherwise defined, and a description for the known function and configuration obscuring the present invention will be omitted in the following description and the accompanying drawings.

A purification apparatus for radioactive wastewater according to the present invention, which is a purification apparatus for radioactive wastewater containing radioactive iodine, includes: an anoxic tank into which wastewater containing radioactive iodine is introduced; and a microbial purification tank communicating with the anoxic tank to thereby receive the introduced wastewater in the anaerobic state and supplied with a metal reducing bacteria source, an electron donor, and a copper ion source, wherein the radioactive iodine and copper ions are bound to each other by the metal reducing bacteria in the microbial purification tank to thereby become copper iodide and precipitate, such that radioactive iodine in wastewater is removed as sludge.

The purification apparatus for radioactive wastewater according to the present invention may remove radioactive iodine contained in the wastewater by biomineralization. In detail, in the purification apparatus for radioactive wastewater according to the present invention, copper ions provided from the copper ion source are reduced from divalent copper to monovalent one by the metal reducing bacteria, and the reduced copper ions selectively bind strongly to radioactive iodine to form a stable crystalline mineral, such that the radioactive iodine contained in the wastewater may be removed.

As described above, the purification apparatus for radioactive wastewater according to the present invention has advantages in that the radioactive wastewater may be economically and rapidly purified using significantly simple devices, that is, the anoxic tank and the microbial purification tank, and even though other anions (Cl⁻, CO₃²⁻, SO₄²⁻, or the like) are present in the wastewater, iodide ions may be selectively removed, thereby obtaining significantly excellent efficiency and selectivity. In addition, since the iodine nuclides contained in the wastewater is removed as the significantly stable crystalline mineral (copper iodide), there are advantages in that a disposal volume of secondary radioactive wastes generated during a purification process of the wastewater may be significantly decreased, and at the same time, long term disposal stability of the secondary radioactive wastes may be increased. Further, since the radioactive iodine may be removed in a solid state by biomineralization, there are advantages in that high level radioactive wastewater containing high concentration radioactive iodine may be treated, and treatment efficiency may be high. In addition, since a pH of the wastewater is maintained in an almost neutral state during the purification process, there is no need for a pH adjusting process of adjusting the pH in order to discharge the wastewater from which the radioactive nuclides are removed, and since the radioactive wastewater may be purified by a significantly simple configuration of allowing the wastewater to be in an anaerobic state and removing the radioactive iodine as the crystalline mineral using biomineralization, exposure of radioactivity may be minimized, and automatic operation may be performed.

In the purification method according to the exemplary embodiment of the present invention, the radioactive wastewater, which is a treatment object, may contain radioactive iodine (iodine nuclides) having a concentration of up to 1 mM and iodine nuclides having a radiation dose of up to 1,000 Bq/ml. In this case, the radioactive iodine (iodide nuclides) may include one or at least two selected from iodide ion (I⁻), iodate ion (IO₃⁻), and iodine (I₂).

The radioactive iodine may be present in the wastewater in forms (chemical species) of iodate ion (IO₃⁻) and iodine (I₂) as well as a form (chemical species) of iodide ion. In the case of removing the radioactive iodine in wastewater using activated carbon or an ion exchange resin as in the related art, removal efficiency is significantly changed according to the form of iodide nuclides present in the wastewater, such that there is a limitation in removing various kinds of radioactive iodine. However, the purification apparatus for radioactive wastewater according to the exemplary embodiment of the present invention includes the anoxic tank in front of the microbial purification tank, such that all of various chemical species of the radioactive iodine contained in the wastewater introduced into the apparatus may be removed.

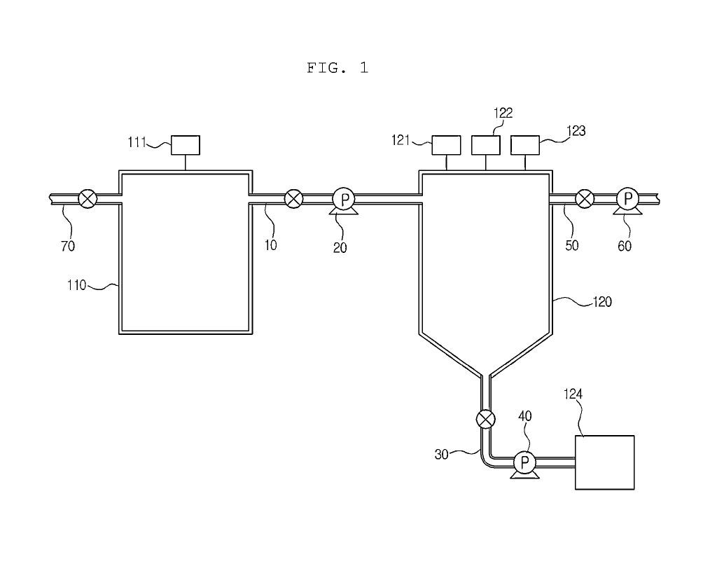

Hereinafter, the present invention will be described in detail with reference to the accompanying drawings. FIG. 1 is a configuration diagram of the purification apparatus of radioactive wastewater according to the exemplary embodiment of the present invention. As shown in FIG. 1, the purification apparatus 100 for radioactive wastewater may include the anoxic tank 110 and the microbial purification tank 120 communicating with the anoxic tank 110. In detail, based on a flow of the radioactive wastewater, the anoxic tank 110 may be provided in front of the microbial purification tank 120.

The wastewater introduced into the anoxic tank 110 may be wastewater containing radioactive iodine, in detail, one or at least two radioactive iodine selected from iodide ion (I⁻), iodate ion (IO₃⁻), and iodine (I₂). According to the scope of the present invention of removing iodine as the crystalline mineral by biomineralization, a concentration of the radioactive iodine in the wastewater is not particularly limited, but the radioactive wastewater introduced into the anoxic tank 110 may contain radioactive iodine (iodine nuclides) at a high concentration of 10 mM.

The anoxic tank 110 may include a wastewater inflow pipe 70 through which the wastewater is introduced from the outside, and the wastewater inflow pipe may be a pipe capable of being opened and closed by a valve. The anoxic tank 110 may be supplied with the radioactive wastewater to be purified to change the radioactive wastewater to be in an anaerobic state, and as the radioactive wastewater is changed to be in the anaerobic state, the various iodine chemical species (IO₃⁻ and I₂) contained in the radioactive wastewater may be changed into a single chemical species (iodide ion (I⁻)). In this case, the anaerobic state may mean a state in which dissolved oxygen (DO) in the wastewater is removed. In this regard, the anoxic tank 110 may be collectively referred to as an anaerobic tank 110.

In order to change the initially oxidative state of the wastewater into the anaerobic state, that is, the achievement for the wastewater to get the single chemical specie of the iodide ion (I⁻) as the radioactive iodine, a reducing agent may be supplied to the anoxic tank 110. In detail, the reducing agent may be supplied by a reducing agent storage tank connected to the anoxic tank 110. In this case, a general stirring device may be provided in the anoxic tank 110 in order to allow the dissolved oxygen to be effectively removed by the reducing agent, and the anoxic tank may be a closed reactor capable of preventing radioactivity from being released to the outside. As the reducing agent, any reducing agent may be used as long as it is used for forming the anaerobic state in the anoxic tank 110. As a specific and non-restrictive example, the reducing agent may be one or at least two materials selected from a group consisting of oxalic acid, formic acid, sodium sulfite, and sodium hydrogen sulfite.

The wastewater changed to be anaerobic state by the reducing agent may be introduced into the microbial purification tank 120. The metal reducing bacteria source, the electron donor, and the copper ion source may be supplied to the microbial purification tank 120 and mixed with the anaerobic wastewater in the microbial purification tank 120.

Since the radioactive iodine nuclides in the wastewater is precipitated as the sludge by biomineralization process and the wastewater is purified in the microbial purification tank 120, as in the example shown in FIG. 1, the microbial purification tank 120 may have a tapered shape in which a lower portion thereof becomes gradually narrow in order to effectively separate the precipitated sludge and the purification water from which the radioactive iodine nuclide is removed. In this case, a tapered shape of a lower portion of the microbial purification tank 120 may include a cone shape. In addition, the microbial purification tank 120 may be provided with a stirring unit including a blade so that the iodine nuclides in the wastewater may be more rapidly removed by the biomineralization process.

The copper ion source may supply copper ions (Cu²⁺) to the wastewater, and the metal reducing bacteria source may supply metal reducing bacteria to the wastewater. The metal reducing bacteria may reduce the copper ion provided from the copper ion source to form monovalent copper ions (Cu¹⁺), and the monovalent copper ions (Cu¹⁺) may strongly bind to the iodide ion to form the crystalline mineral of copper iodide (CuI). In this case, the electron donor may serve to activate metal reducing bacteria and supply electrons required at the time of reducing the copper (Cu²⁺) ion.

Since the copper ion source is a source supplying copper ions for forming the crystalline mineral of copper iodide, any copper salt may be used as long as it may provide the copper ion to the wastewater and be easily dissolved in water. As a specific and non-restrictive example, the copper salt used as the copper ion source may be one or at least two materials selected from a group consisting of copper sulfate, copper acetate, copper chloride, copper bromide, copper chlorate, copper perchlorate, copper nitride, and copper nitrate.

Preferably, the copper ion source may be copper sulfate. Copper sulfate may improve the removal efficiency of iodide by the metal reducing bacteria. In detail, while the sulfate salt is reduced to sulfur by the metal reducing bacteria and at the same time, the divalent copper ion is reduced and stabilized to the monovalent copper ion, the crystalline mineral of CuI is precipitated, such that the removal efficiency of iodine may be improved.

The metal reducing bacteria source may be powdery metal reducing bacteria itself or a culture medium containing metal reducing bacteria. In this case, the powder of the metal reducing bacteria may be powder formed by freeze-drying a liquid containing the metal reducing bacteria. The metal reducing bacteria may be any one or at least two selected from Pseudomonas, Shewanella, Chlostridium, Desulfovibrio, Desulfosporosinus, Desulfotomaculum, Anaeromyxobacter, and Geobacter genera.

The electron donor may serve to supply electrons required in the Cu²⁺ reduction process by the metal reducing bacteria. To this end, it is preferable that the electron donor may be at least one selected from an organic acid and hydrogen gas, wherein the organic acid may be a carboxylic group containing organic acid, a sulfonic acid group containing organic acid, or a mixed acid thereof. The carboxylic group containing organic acid may be any one or at least two selected from citric acid, succinic acid, tartaric acid, formic acid, oxalic acid, malic acid, malonic acid, benzoic acid, maleic acid, gluconic acid, glycolic acid, and lactic acid. The sulfonic acid group containing organic acid may be any one or at least two selected from methanesulfonic acid, ethanesulfonic acid, propanesulfonic acid, aminomethanesulfonic acid, benzenesulfonic acid, toluene sulfonic acid (4-methylbenzenesulfonic acid), sodium toluene sulfonate, phenolsulfonic acid, pyridinesulfonic acid, dodecylbenzene sulfonic acid, 2-methylphenolsulfonic acid, and methylphenolsulfonic acid. In the case in which the electron donor is the organic acid, it is preferable that the organic acid is oxycarboxylic acid such as lactic acid, tartaric acid, and citric acid.

In the case in which the electron donor is hydrogen gas, the electron donor may be pure hydrogen gas or a mixed gas in which hydrogen gas and inert gas are mixed with each other, wherein the mixed gas may contain 0.5 to 5 vol % of hydrogen gas.

The purification apparatus for radioactive wastewater according to an exemplary embodiment of the present invention has an advantage in that the purification water purified in the microbial purification tank 120 may be directly discharged without post-treatment. This advantage may be obtained by converting various radioactive iodine chemical species in the wastewater into the single iodide ion in the anoxic tank 110 and chemically binding the copper ion and iodide ion to each other using the metal reducing bacteria to remove the radioactive iodide ion as the crystalline mineral. In detail, as the copper ion and the iodide ion are significantly selectively bound to each other by any one or at least two metal reducing bacteria selected from Pseudomonas, Shewanella, Chlostridium, Desulfovibrio, Desulfosporosinus, Desulfotomaculum, Anaeromyxobacter, and Geobacter genera, purification of the radioactive wastewater may be performed by injecting the copper ion source so that the same amount of copper ion is formed as that of the radioactive iodine contained in the wastewater. In addition, when the electron donor is oxycarboxylic acid, activation of the metal reducing bacteria is promoted and the divalent copper ion may be gradually reduced to monovalent one by the metal reducing bacteria even in the case of using a trace amount of electron donor. As described above, the radioactive iodine may be effectively removed even in the case of using the almost same amount of the copper ion source as that of the radioactive iodine in the wastewater, and the electron supply via the activation of the metal reducing bacteria may effectively work even in the case of using the trace amount of organic electron donor. The purification water purified in the microbial purification tank 120 may be directly discharged or reused without post-treatment.

As described above, in order to unify the chemical species of the radioactive iodine in the wastewater as the iodide ion (I⁻) and remove the iodide ion as the crystalline mineral of copper iodide by biomineralization process, the purification apparatus for radioactive wastewater according to the exemplary embodiment of the present invention may include a reducing agent storage tank 111 connected to the anoxic tank 110 and a metal reducing bacteria source storage tank 121, an electron donor storage tank 122, and a copper ion source storage tank 123 connected to the microbial purification tank 120, respectively.

The reducing agent storage tank 111 may be connected to the anoxic tank 110 by an openable and closable pipe to supply the previously-mentioned reducing agent itself or an aqueous-type reducing agent. In this case, the pipe connecting the reducing agent storage tank 111 and the anoxic tank 110 to each other may be connected to a pump for transferring the reducing agent and supplying a fixed amount of the reducing agent.

The metal reducing bacteria source storage tank 121 may be connected to the microbial purification tank 120 by an openable and closable pipe (pipe equipped with a valve) to store and supply the above-mentioned metal reducing bacteria source itself or water sludge or a water dispersion solution of the metal reducing bacteria source. In this case, the pipe connecting the metal reducing bacteria storage tank 121 and the microbial purification tank 120 to each other may be connected to a pump for transferring the metal reducing bacteria source and supplying a fixed amount of the metal reducing bacteria source.

The electron donor storage tank 122 may be connected to the microbial purification tank 120 by an openable and closable pipe (pipe equipped with a valve) to supply the previously-mentioned electron donor itself or an aqueous-type electron donor. In this case, when the electron donor is an organic acid, the pipe connecting the electron donor storage tank 122 and the microbial purification tank 120 to each other may be connected to a pump for transferring the electron donor and supplying a fixed amount of the electron donor. In this case, when the electron donor is hydrogen gas, the pipe connecting the electron donor storage tank 122 and the microbial purification tank 120 to each other may be connected to a general gas flow control unit such as mass flow control (MFC) for supplying a fixed amount of the electron donor. Further, in order to allow the gas to be effectively supplied to the wastewater in the microbial purification tank 120, one end of the pipe connecting the electron donor storage tank 122 and the microbial purification tank 120 to each other at the microbial purification tank 120 may be positioned in the microbial purification tank 120 so that the gas may be charged in the wastewater, and an air diffuser may be provided at one end.

The copper ion source storage tank 123 may be connected to the microbial purification tank 120 by an openable and closable pipe (pipe equipped with a valve) to store and supply the above-mentioned copper ion source itself or an aqueous copper ion source. In this case, the pipe connecting the copper ion source storage tank 123 and the microbial purification tank 120 to each other may be connected to a pump for transferring of the copper ion source and supplying a fixed amount of the copper ion source.

As shown in FIG. 1, the purification apparatus for radioactive wastewater may further include a first transfer pipe 10 and a sludge discharge pipe 30, which are openable and closable transfer pipes, a pump 20 or 40 moving the wastewater or sludge, a purification water discharge pipe 50 for discharging the purification water from which the iodine nuclide is removed, and a pump 60 discharging the purification water.

In detail, the purification apparatus for radioactive wastewater may further include the first transfer pipe 10 allowing the anoxic tank 110 and the microbial purification tank 120 to communicate with each other so as to be openable and closable; a first transfer pump 20 connected to the first transfer pipe 10 to transfer the wastewater in the anoxic tank 110 to the microbial purification tank 120; the sludge discharge pipe 30 installed so as to communicate with a lower portion of the microbial purification tank 120 to thereby be openable and closable; and a sludge discharge pump 40 connected to the sludge discharge pipe 30 to discharge the sludge in the microbial purification tank 120. In addition, the purification apparatus of radioactive wastewater may further include the purification water discharge pipe 50 installed so as to communicate with the microbial purification tank 120 to thereby be openable and closable; and the purification water discharge pump 60 connected to the purification water discharge pipe 50 to discharge the purification water from which the iodine nuclide is removed.

One end of the first transfer pipe 10 is coupled to the anoxic tank 110 and the other end thereof is coupled to the microbial purification tank 120, such that the first transfer pipe provides a pathway through which the wastewater in the anaerobic state is transferred from the anoxic tank 110 to the microbial purification tank 120. The first transfer pipe 10 may be a transfer pipe provided with the valve adjusting an opening and closing of the pipe so as to prevent the wastewater from moving to the microbial purification tank 120 while the radioactive wastewater is introduced into the anoxic tank 110 and changed to be in the anaerobic state while maintaining a predetermined water level, and allow the wastewater in the anaerobic state to move to the microbial purification tank 120. The first transfer pump 20 may be connected to the first transfer pipe 10 to move the wastewater in the anaerobic state from the anoxic tank 110 to the microbial purification tank 120 through the first transfer pipe 10.

The anionic iodine nuclide (I⁻) in the radioactive wastewater may be removed as the crystalline mineral of copper iodide in the microbial purification tank 120. Therefore, the radioactive iodine nuclide is precipitated at a lower portion of the microbial purification tank 120 to form the sludge, and the sludge containing the crystalline mineral of copper iodide is discharged and removed through the sludge discharge pipe 30 installed so as to communicate with the lower portion of the microbial purification tank 120 to thereby be openable and closable. In detail, the sludge discharge pipe 30 may include the valve adjusting an opening and closing of the pipe, and one end thereof may be connected to the lower portion of the microbial purification tank 120 and the other end thereof may be connected to a sludge storage tank storing the discharged sludge. The sludge discharge pump 40 may be connected to the sludge discharge pipe 30 to move the sludge precipitated at the lower portion of the microbial purification tank 120 to the sludge storage tank 124 through the sludge discharge pipe 30. In this case, the front of the sludge storage tank 124 may be further provided with a dehydration tank dehydrating the sludge discharged through the sludge discharge pipe, and the sludge dehydrated by the dehydration tank may be introduced and stored in the sludge storage tank 124. In this case, the dehydrated sludge may be finally disposed as a solid state radioactive waste.

The radioactive iodine nuclides in the wastewater is biomineralized to copper iodide, such that the sludge is formed at the lower portion of the microbial purification tank 120, and the purification water from which the radioactive iodine nuclide is removed is formed at an upper portion of the sludge. The purification water may be discharged through the openable and closable purification water discharge pipe 50 connected to the microbial purification tank 120. Since the pH of the wastewater may be maintained at the nearly neutral pH, the purification water may be directly discharged or reused without post-treatment.

In order to prevent the radioactivity from affecting human being and safely remove the radioactive nuclides, it is preferable that the purification of the wastewater is automatically performed. In the purification apparatus for radioactive wastewater according to the exemplary embodiment of the present invention, the iodine nuclide in the wastewater is removed as the mineral crystal using the metal reducing bacteria after removing oxygen present in the radioactive wastewater, such that automation of the apparatus is significantly easy.

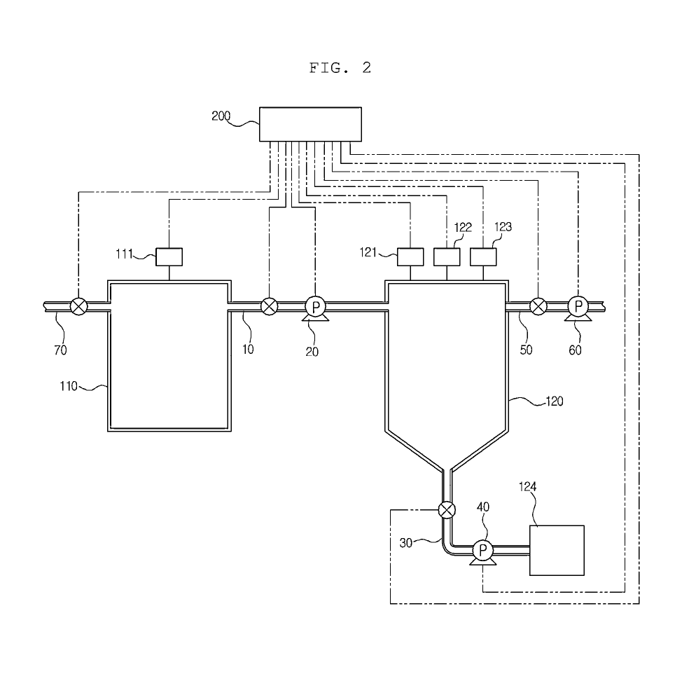

FIG. 2 is another configuration diagram of the purification apparatus of radioactive wastewater according to an exemplary embodiment of the present invention. As in the example shown in FIG. 2, the purification apparatus of radioactive wastewater may further include a control part 200 controlling the transferring of the radioactive wastewater, injection of each material used in purification of the radioactive wastewater, and discharge of the sludge and purification water.

In detail, the control part 200 may control an openable and closable radioactive wastewater inflow pipe connected to the anoxic tank 110, which is a closed tank, to adjust whether or not the radioactive wastewater is introduced and an amount of the radioactive wastewater in the anoxic tank 110, and control the first transfer pipe 10 and the first transfer pump 20 to control whether or not the wastewater is transferred from the anoxic tank 110 to the microbial purification tank 120, which is a closed tank. After a predetermined amount of radioactive wastewater is introduced into the anoxic tank 110 by the control part 200, the control part 200 may control a transfer pipe and pump of the reducing agent storage tank 111 so that a predetermined amount of reducing agent is injected from the reducing agent storage tank 111 into the anoxic tank 110. The amount of the reducing agent injected by the control part 200 may be appropriately adjusted in consideration of an amount of the radioactive wastewater treated in the anoxic tank 110. In this case, it is preferable that the amount of the reducing agent is an amount capable of removing the dissolved oxygen in the wastewater and converting iodine oxide (for example, IO₃⁻, or I₂) into reduced iodine (I⁻). In detail, it is preferable that the amount of the reducing agent injected into the wastewater is injected so as to have a concentration (concentration of the reducing agent) equal to or more than a sum of concentrations of the iodine oxide and the dissolved oxygen in the wastewater. As a specific and non-restrictive example, the reducing agent may be injected so as to have a concentration of 0.01 to 100 mM.

After the oxidative radioactive wastewater is changed to be anaerobic state in the anoxic tank 110, the control part 200 may control the first transfer pipe 10 and the first transfer pump 20 to move the wastewater in the anaerobic state from the anoxic tank 110 to the microbial purification tank 120. Thereafter, the control part 200 may control an opening and closing of the transfer pipe of each of the storage tanks 121, 122, and 123 and an operation of the pump so that predetermined amounts of the metal reducing bacteria source, the electron donor, and the copper ion source may be injected from the metal reducing bacteria source storage tank 121, the electron donor storage tank 122, and the copper ion source storage tank 123 to the microbial purification tank 120.

The control part 200 may control the opening and closing of the transfer pipe of each of the storage tanks 121, 122, and 123 and the operation of the pump so that the electron donor supplying the electron, the metal reducing bacteria source, and the copper ion source may be sequentially injected at the time of activating bacteria and reducing the metal.

It is preferable that an injection amount of the electron donor by the control part 200 is an amount capable of activating the metal reducing bacteria and smoothly supplying the electron required at the time of reduction reaction by the metal reducing bacteria. As a specific example, in the case in which the electron donor is hydrogen gas, the control part may inject the gas so that a concentration of dissolved hydrogen in the wastewater is 10 ppm (ppm based on mole fraction) or less, specifically 0.1 to 10 ppm, and more specifically 0.1 to 2 ppm. As a specific example, in the case in which the electron donor is an organic acid, 1 to 20 mM organic acid may be supplied, based on 1 mM copper ion by the copper ion source injected into the wastewater. In the case in which a content of the injected organic acid is less than 1 mM, activation of the metal reducing bacteria and formation of the monovalent copper ion are not smoothly performed, and in the case in which the content is more than 20 mM, an effect of improving copper ion formation efficiency is insignificant, but the purification water may be contaminated by the excessive electron donor and the crystalline mineral of copper iodide may be atomized by excessively rapid proliferation of the metal reducing bacteria.

Preferably, the control part 200 may supply a trace amount of the metal reducing bacteria to the microbial purification tank 120. The trace amount of the metal reducing bacteria may prevent a large amount of copper iodide seed from being formed at an initial stage of purification and allow a seed of copper iodide to grow into a coarse crystal grain in the microbial purification tank 120 as the metal reducing bacteria is proliferated. Therefore, crystalline mineral of copper iodide having a coarse size may be formed and be effectively discharged as the sludge, and stability of the secondary radioactive material, that is, copper iodide, may be significantly increased.

In detail, the control part 200 may supply the metal reducing bacteria source to the wastewater so that 100 ppm (ppm based on weight) or less, preferably 100 to 0.005 ppm, more preferably 10 to 0.005 ppm, most preferably 1 to 0.005 ppm of the metal reducing bacteria is injected, based on an amount of protein. At an initial stage of the purification, formation of the large amount of copper iodide seed may be prevented by the trace amount (10 ppm or less, preferably 1 ppm or less) of the metal reducing bacteria, and growth of the copper iodide seed formed at the initial stage is promoted by proliferation of the metal reducing bacteria itself in the microbial purification tank 120, such that the crystal mineral may be coarsened so as to have a micrometer order size.

As described above, the trace amount of the metal reducing bacteria is injected into the microbial purification tank 120 by the control part 200 and the metal reducing bacteria itself is proliferated during a purification process in the microbial purification tank 120, such that a rate of biomineralization is controlled at initial and middle stages of purification, thereby making it possible to remove the iodine nuclide in the form of the coarse crystalline mineral. To this end, a proliferation rate of the metal reducing bacteria during the purification process should not be excessively rapid or slow but be suitable. To this end, it is preferable that an organic acid such as oxycarboxylic acid is injected as the electron donor.

Preferably, the control part 200 may inject the copper ion source into the microbial purification tank 120 so that the copper ions are formed at an amount almost equal to that of the iodine nuclide contained in the radioactive wastewater. That is, as described above, since an effect by other anions capable of being present in the wastewater together with the iodine nuclide may be excluded, the control part 200 may supply the copper ion source to the microbial purification tank 120 so that a concentration of the copper ion formed in the wastewater is 1 to 1.5 mM based on 1 mM of iodine nuclide contained in the radioactive wastewater. In the case of injecting the copper ion source so that the content of the formed copper ion is less than 1 mM, the copper ion capable of binding with the iodide nuclide at a ratio of 1:1 is insufficient, such that the iodine nuclide in the wastewater may not be completely removed, and in the case of injecting the copper ion source so that the content of the formed copper ion is more than 1.5 mM, the effect of improving iodine nuclide removing efficiency is insignificant, but the purification water may be contaminated by the excessive copper ion source.

After the radioactive iodine nuclide is precipitated as the sludge by the biomineralization process by the metal reducing bacteria in the microbial purification tank 120 and purification of the wastewater is completed, the control part 200 may control the sludge discharge pipe 30 and sludge discharge pump 40 to separate and discharge the sludge precipitated at the lower portion of the microbial purification tank 120 and then control the purification water discharge pipe 50 and the purification water discharge pump 60 to discharge the purification water from which the radioactive nuclide is removed.

As described above, the control part 200 may introduce the radioactive wastewater into the anoxic tank 110, inject the reducing agent into the anoxic tank 110 to change the radioactive wastewater to be in the anaerobic state, transfer the radioactive wastewater in the anaerobic state to the microbial purification tank 120, sequentially inject (supply) the electron donor, the metal reducing bacteria source, and the copper ion source into the microbial purification tank 120 to precipitate the iodine nuclide by the biomineralization process as the sludge, and separate and discharge each of the sludge and the purification water from which the iodine nuclide is removed through each of the outlets provided in the microbial purification tank 120.

In this case, when the stirring units are provided in the anoxic tank 110 and the microbial purification tank 120, respectively, the control part 200 may control each of the stirring units so as to perform the stirring while the wastewater is changed to be in the anaerobic state in the anoxic tank 110 and purification of the wastewater is performed in the anaerobic state by the biomineralization mechanism in the microbial purification tank 120, and stop the operation of the stirring units to maintain at a stationary state for a predetermined time so that precipitation is performed after the radioactive iodine nuclide is removed by the biomineralization mechanism.

In consideration of the content of the iodine nuclide in the radioactive wastewater, an amount of the treated radioactive wastewater (treatment volume, that is, a size of the anoxic tank or microbial purification tank), or the like, a time for the anaerobic state, a time for performing the biomineralization mechanism, a time for stationary state for precipitation as the sludge, and the like, may be determined. As a specific and non-restrictive example, based on wastewater containing 1 mM radioactive iodine and a wastewater treatment volume of 1 ton, the control part 200 may control the anoxic tank 110 and the microbial purification tank 120 so that the radioactive wastewater is changed to be anaerobic state for 1 to 5 hours after the reducing agent is supplied to the anoxic tank 110, the iodine nuclide is biomineralized with stirring for 1 to 10 days after the electron donor, the metal reducing bacteria source, and the copper ion source are supplied to the microbial purification tank 120, and the resultant is stationary for 2 to 12 hours in order to allow the sludge to be precipitated at the lower portion of the microbial purification tank 120.

In addition, for continuous purification of the wastewater, the control part 200 may control each of the anoxic tank 110 and the microbial purification tank 120 so that the radioactive wastewater is changed in the anaerobic state in the anoxic tank 110 while purification by the biomineralization process is performed in the microbial purification tank 120 after the wastewater in the anaerobic state is moved from the anoxic tank 110 to the microbial purification tank 120.

In order to observe influences of other anions frequently present in wastewater such as CO₃²⁻ and Cl⁻ together with the iodide ion, an aqueous solution containing NaHCO₃ (3 mM), NaCl (1 mM), Na₂SO₄ (1 mM), and NaI (1 mM) as an iodide ion source was prepared. Cu(NO₃)₂.3H₂O as the copper ion source, Na-lactate as the electron donor, and Desulfosporosinus auripigmenti as the metal reducing bacteria were used in the prepared aqueous solution. A concentration of the copper ion source was 1 mM, a concentration of sodium lactate was 10 mM, and as the metal reducing bacteria, 1 ml of a culture medium of Desulfosporosinus was injected so that 1 ppm (weight ppm, based on a protein amount) of Desulfosporosinus was injected into 100 ml of the aqueous solution.

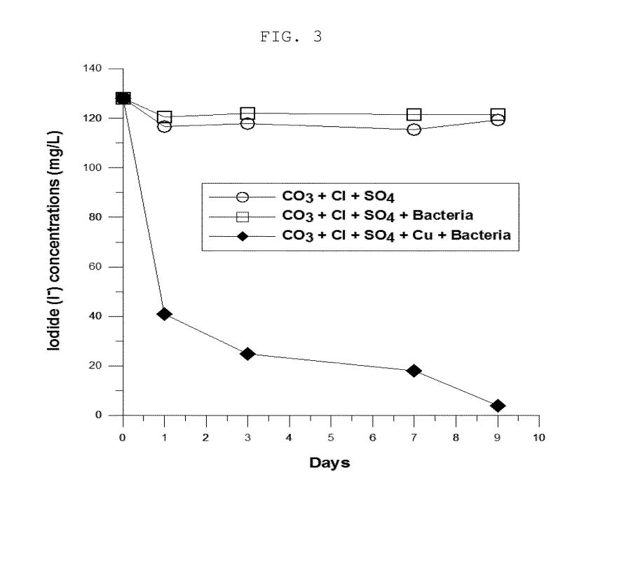

FIG. 3 shows results of measuring an amount of iodide ion (‘CO₃+Cl+SiO₄+Cu+Bacteria’ in FIG. 3) remaining in the aqueous solution according to the time after injecting the copper ion source, the electron donor, and the metal reducing bacteria. In FIG. 3, ‘CO₃+Cl+SiO₄+Bacteria’ indicates the result obtained when an experiment was performed under the same conditions except that the copper ion source was not injected into the aqueous solution, and ‘CO₃+Cl+SiO₄’ indicates the result obtained when an experiment was performed under the same conditions except that the copper ion source, the electron donor, and the bacteria were not injected.

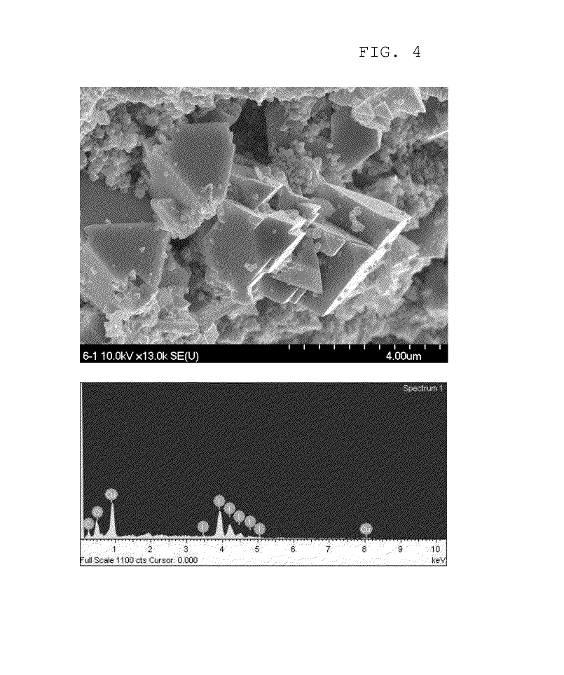

As shown in FIG. 3, it may be confirmed that even though the anions such as CO₃²⁻, Cl⁻, and SO₄²⁻ co-exist, most of the iodide ions (I⁻) were selectively removed. In addition, it may be appreciated that only in the case of supplying the copper ion, an effect of removing the iodine was shown, and in the case in which copper was not present, in spite of the presence of the metal reducing bacteria, the effect of removing the iodine was hardly shown. Further, it may be confirmed that even though the concentration of the copper ion by the copper ion source and the concentration of the iodide ion (I⁻) were equal to each other, the iodide ion was effectively removed. That is, it may be appreciated that the divalent copper ion was changed into the monovalent copper ion by the metal reducing bacteria and bound to the iodide ion at a ratio of 1:1 to thereby be mostly removed in a form of the crystalline mineral of CuI (See FIG. 4). At this time, the other anions such as CO₃²⁻, Cl⁻, and SO₄²⁻ mostly remained in the aqueous solution in dissolved forms.

FIG. 4 is a photograph obtained by recovering and observing sludge precipitated at a lower portion of the aqueous solution after 9 days of the reaction using an electron microscope. As shown in FIG. 4, it was confirmed that development of the crystal of the copper iodide (CuI) mineral was significantly excellent, and significantly coarse mineral crystal (size≧μm) was formed. As a result of chemically analyzing the recovered sludge, other anions except for iodine and copper were not almost detected, and a small amount of carbonate (CO₃) was contained therein. In addition, the crystalline mineral of copper iodide was easily precipitated and hardly oxidized in the air, and stabilized crystalline mineral form was maintained.

In the purification apparatus for radioactive wastewater according to the present invention, since the monovalent copper ion reduced by the metal reducing bacteria strongly binds to the iodine nuclide to thereby be precipitated and removed as the crystalline mineral of copper iodide by the significantly simple configuration in which the radioactive wastewater is changed to be in the anaerobic state in the anoxic tank and then the metal reducing bacteria source, the electron donor, and the copper ion source are mixed with the wastewater in the anaerobic state in the microbial purification tank, the radioactive wastewater may be economically and rapidly purified by the simple apparatus, and the iodine nuclide may be significantly efficiently and selectively removed. In addition, purification apparatus for radioactive wastewater according to the present invention, the disposal volume of the secondary radioactive material generated during the purification process of the wastewater may be significantly decreased, and stability of the secondary radioactive material may be high. Further, in the purification apparatus for radioactive wastewater according to the present invention, high level radioactive wastewater may be treated, a post-treatment apparatus for discharging the wastewater from which the radioactive nuclide is removed may not be required, human being exposure to the radioactivity may be minimized during the treatment process of the radioactive wastewater, and an automatic operation may be performed.

Hereinabove, although the present invention is described by specific matters, exemplary embodiments, and drawings, they are provided only for assisting in the entire understanding of the present invention. Therefore, the present invention is not limited to the exemplary embodiments. Various modifications and changes may be made by those skilled in the art to which the present invention pertains from this description.

Therefore, the spirit of the present invention should not be limited to the above-described examples, and the following claims as well as all modified equally or equivalently to the claims are intended to fall within the scope and spirit of the invention.

What is claimed is:

1. A purification apparatus for radioactive wastewater comprising:
an anoxic tank into which wastewater containing radioactive iodine is introduced; and
a microbial purification tank connected to the anoxic tank so as to allow wastewater in an anaerobic state to be introduced and supplied with a metal reducing bacteria source, an electron donor, and a copper ion source,
wherein radioactive iodide and copper ions are bound to each other to form copper iodide by metal reducing bacteria, and the formed copper iodide is precipitated in the microbial purification tank, such that the radioactive iodide in the wastewater is removed as sludge.

2. The purification apparatus for radioactive wastewater of claim 1, further comprising:
a first transfer pipe allowing the anoxic tank and the microbial purification tank to communicate with each other so as to be openable and closable;
a first transfer pump connected to the first transfer pipe to transfer the wastewater in the anoxic tank to the microbial purification tank;
a sludge discharge pipe installed so as to communicate with a lower portion of the microbial purification tank to thereby be openable and closable; and
a sludge discharge pump connected to the sludge discharge pipe to discharge the sludge in the microbial purification tank.

3. The purification apparatus for radioactive wastewater of claim 2, further comprising a metal reducing bacteria source storage tank, an electron donor storage tank, and a copper ion source storage tank connected to the microbial purification tank, respectively.

4. The purification apparatus for radioactive wastewater of claim 1, further comprising a control part,
wherein the control part injects the metal reducing bacteria source so that at most 100 ppm metal reducing bacteria is injected thereinto, based on a protein amount of the metal reducing bacteria.

5. The purification apparatus for radioactive wastewater of claim 4, wherein the control part injects the copper ion source so that 1 to 1.5 mM copper ion is formed based on 1 mM radioactive iodine contained in the wastewater.

6. The purification apparatus for radioactive wastewater of claim 1, wherein the metal reducing bacteria is any one or at least two selected from Pseudomonas, Shewanella, Chlostridium, Desulfovibrio, Desulfosporosinus, Desulfotomaculum, Anaeromyxobacter, and Geobacter genera.

7. The purification apparatus for radioactive wastewater of claim 1, wherein the metal reducing bacteria source is metal reducing bacteria powder or a culture medium containing the metal reducing bacteria.

8. The purification apparatus for radioactive wastewater of claim 1, wherein the electron donor is one or at least two selected from a carboxylic group containing organic acid, a sulfonic acid group containing organic acid, and hydrogen gas.
